(19) United States
(12) Patent Application Publication
(10) Pub. No.: US 2007/0099710 A1
(43) Pub. Date: May 3, 2007

(54) Flexible flywheel

(75) Inventors: Kozo Yamamoto, Osaka (JP); Hiroyoshi Tsuruta, Osaka (JP); Hiroshi Uehara, Osaka (JP)

Correspondence Address: GLOBAL IP COUNSELORS, LLP, 1233 20TH STREET, NW, SUITE 700, WASHINGTON, DC, 20036-2680, US

(73) Assignee: Exedy Corporation, Neyagawa-shi (JP)

(21) Appl. No.: 10/571,894

(22) PCT Filed: Sep. 7, 2004
(86) PCT No.: PCT/JP04/12986

§ 371 Date: Mar. 14, 2006

(30) Foreign Application Priority Data
Sep. 16, 2003 (JP) 2003-323630
Sep. 17, 2003 (JP) 2003-324294
Oct. 7, 2003 (JP) 2003-347721

(51) Int. Cl. F16F 15/121

(52) U.S. Cl. 464/68.1

(57) ABSTRACT

A flexible flywheel is a member to which torque is input from a crankshaft 91 of the engine and includes a first flywheel 2 and a damper mechanism 4. The first flywheel 2 includes an inertia member 13, and a flexible plate 11 for connecting the inertia member 13 with the crankshaft 91. The flexible plate is flexibly deformable in the bending direction. The damper mechanism 4 includes an input-side disc-like plate 20 to which torque is input from the crankshaft 91, output plates 32 and 33 located rotatable relative to the input-side disc-like plate 20, and coil springs 34, 35, and 36 to be compressed in the rotational direction when both the plates rotate relative to each other. The first flywheel 2 can move relative to the damper mechanism 4 in the bending direction with a limited range.

### TECHNICAL FIELD

The present invention is related to a flexible flywheel, particularly to a flexible flywheel having a flexible plate for flexibly connecting an inertia member with a crankshaft in the bending direction.

### BACKGROUND ART

Conventionally, a flywheel is attached to a crankshaft of an engine for absorbing vibrations caused by combustion variations in the engine. Further, a clutch device is arranged on an axial-direction transmission side with respect to the flywheel. The clutch device usually includes a clutch disc assembly coupled to an input shaft of the transmission and a clutch cover assembly for biasing a frictional coupling portion of the clutch disc assembly against the flywheel. The clutch disc assembly typically has a damper mechanism for absorbing and damping torsional vibrations. The damper mechanism has elastic members such as coil springs arranged for compression in a rotating direction.

Furthermore, a structure is known in which a flywheel is connected to a crankshaft via a flexible plate in order to absorb bending vibrations from the engine (refer to Patent Document 1). The flexible plate has a relatively high rigidity in the rotational direction to transmit torque, but has relatively low rigidities in the axial and bending directions. The structure in which the flywheel is connected to the crankshaft via the flexible plate is referred to as a flexible flywheel below.

It is noted that the output side of the damper mechanism is fixed to a hub flange which is directly engaged with the transmission input shaft or to a second flywheel onto which a clutch device is attached. In the latter case, torque from the damper mechanism is transmitted to the transmission input shaft through the second flywheel and the clutch disc assembly with the clutch in an engagement state.

Patent Document 1

Unexamined Patent Publication 2001-12552

### DISCLOSURE OF INVENTION

Some of the known flexible flywheels further have a damper mechanism to which torque from the crankshaft is input. The damper mechanism includes an input member to which torque from the crankshaft is input, an output member rotatably located relative to the input member, and an elastic member to be compressed in the rotational direction when the input member and the output member rotate relative to each other. The damper mechanism is typically engaged with the flywheel so that the flexible plate cannot sufficiently flex in the bending direction when the bending vibrations are transmitted from the crankshaft of the engine to the first flywheel. Therefore, it is difficult to achieve enough bending vibration suppressive (flexible) effects.

It is an object of the present invention to achieve an enough of a bending vibration suppressing effect from the crankshaft of the engine in a flexible flywheel having a flexible plate for flexibly connecting an inertia member to the crankshaft in the bending direction.

According to a flexible flywheel of claim 1, to which torque is input from a crankshaft of an engine, the flexible flywheel includes a first flywheel and a damper mechanism. The first flywheel has an inertia member and a flexible plate for connecting the inertia member with the crankshaft. The flexible plate is flexibly deformable in the bending direction and the axial direction. The damper mechanism includes an input member to which torque is input from the crankshaft, an output member located relatively rotatable to the input member, and an elastic member to be compressed in the rotational direction when the input member and the output member rotate relative to each other. The first flywheel can move relative to the damper mechanism in the bending direction within a limited range.

In this flexible flywheel, torque from the crankshaft of the engine is transmitted to the first flywheel and the damper mechanism. When torsional vibrations are generated in the damper mechanism, the input member and the output member rotate relative to each other to compress the elastic member therebetween in the rotational direction. As a result, torsional vibrations are absorbed. When bending vibrations are generated in the first flywheel, the flexible plate flexes in the bending direction. As a result, the bending vibrations from the engine are reduced. In this flexible flywheel, since the first flywheel can move relative to the damper mechanism in the bending direction within a limited range, the bending vibration suppressive effects of the flexible plate are sufficiently high.

According to a flexible flywheel of claim 2 depending on claim 1, the flexible flywheel further includes a friction generation mechanism located between the first flywheel and the output member of the damper mechanism to operate in parallel with the elastic member in the rotational direction. The friction generation mechanism includes two members which are engaged with each other such that the two members can transmit torque therebetween but can move relative each other in the bending direction.

In this flexible flywheel, when torsional vibrations are generated in the damper mechanism, the input member and the output member rotate relative to each other to compress the elastic member between both the members in the rotational direction. At the same time, the friction generation mechanism operates to generate friction. In this flexible flywheel, since the friction generation mechanism has two members engaged with each other so as to be movable relative to each other in the bending direction, the first flywheel can move relative to the damper mechanism in the bending direction with a limited range, although the first flywheel is engaged with the damper mechanism via the friction generation mechanism. As a result, the bending vibration suppressive effects of the flexible plate are sufficiently high.

According to a flexible flywheel of claim 3 depending on claim 2, the two members are a friction member and an engagement member engaged with the friction member.

According to a flexible flywheel of claim 4 depending on claim 3, the friction member and the engagement member are engaged with each other to maintain a gap therebetween in the rotational direction. That is, both members are not in close contact with each other in the rotational direction so that a large resistance is not generated when both members move relative to each other in the bending direction.

According to a flexible flywheel of claim 5 depending on claim 3 or 4, the engagement member is further engaged with another member so as to be movable in the axial direction. Accordingly, resistance between both the members in the axial direction is unlikely to be generated.

According to a flexible flywheel of claim 6 depending on claim 3 or 4, the friction member can slide against the first flywheel in the rotational direction. The engagement member can rotate integrally with the output member of the damper mechanism.

According to a flexible flywheel of claim 7 depending on claim 6, the engagement member is engaged with the output member of the damper mechanism so as to be movable relative to each other in the axial direction. Accordingly, when the friction member moves together with the first flywheel in the axial direction, resistance between the engagement member and the output member is unlikely to be generated in the axial direction.

According to a flexible flywheel of claim 8 depending on any of claims 1 to 7, the flexible flywheel further includes a second flywheel fixed to the output member of the damper mechanism.

According to a flexible flywheel of 9 depending on claim 8, the second flywheel is formed with a frictional face with which a clutch is frictionally engaged.

In a flexible flywheel according to the present invention, bending vibrations from the crankshaft of the engine is sufficiently reduced, in a flexible flywheel having a flexible plate for flexibly fixing the inertia member with the crankshaft in the bending direction.

### BRIEF DESCRIPTION OF DRAWINGS

FIG. 1 is a schematic cross-sectional view of a dual-mass flywheel in accordance with a preferred embodiment of the present invention.

FIG. 2 is an alternate schematic cross-sectional view of the dual-mass flywheel in accordance with a preferred embodiment of the present invention.

FIG. 3 is an elevational view of the dual-mass flywheel.

FIG. 4 is an enlarged fragmentary cross-sectional view that particularly illustrates a second friction generation mechanism of FIG. 1.

FIG. 5 is a schematic, plan view to illustrate a structure of the second friction generation mechanism.

FIG. 6 is a plan view to illustrate a relationship between a friction washer and an engagement member of the second friction generation mechanism.

FIG. 7 is an enlarged fragmentary cross-sectional view that particularly illustrates a first friction generation mechanism of FIG. 1.

FIG. 8 is an enlarged fragmentary cross-sectional view that particularly illustrates the first friction generation mechanism of FIG. 1.

FIG. 9 is an enlarged fragmentary cross-sectional view that particularly illustrates the first friction generation mechanism of FIG. 3.

FIG. 10 is an elevational view of a first friction member.

FIG. 11 is an elevational view of an input-side disc-like plate.

FIG. 12 is an elevational view of a washer.

FIG. 13 is an elevational view of a cone spring.

FIG. 14 is an elevational view of a second friction member.

FIG. 15 is a view of a mechanical circuit diagram of a damper mechanism and a friction generation mechanism.

FIG. 16 is a view of a graph that illustrates torsion characteristics of the damper mechanism.

FIG. 17 is a view of a graph that illustrates torsion characteristics of the damper mechanism.

FIG. 18 is a view of a graph that illustrates torsion characteristics of the damper mechanism.

FIG. 19 is a view of a graph that illustrates torsion characteristics of the damper mechanism.

FIG. 20 is a schematic cross-sectional view of a flywheel damper in accordance with a second embodiment of the present invention.

FIG. 21 is an alternate schematic cross-sectional view of a flywheel damper in accordance with a third embodiment of the present invention.

### EXPLANATIONS OF LETTERS OR NUMERALS

1 dual-mass flywheel
2 first flywheel
3 second flywheel
4 damper mechanism
5 first friction generation mechanism
6 second friction generation mechanism (friction generation mechanism)
11 flexible plate
12 second disc-like plate
13 inertia member
20 input-side disc-like plate (input member)
32 output-side disc-like plate (output member)
33 output-side disc-like plate (output member)
34 first coil spring (elastic member)
35 second coil spring (elastic member)
36 third coil spring (elastic member)
57 friction washer (friction member)
60 frictional engagement member (engagement member)

### BEST MODE FOR CARRYING OUT THE INVENTION

### 1. First Embodiment

(1) Structure

1) Overall Structure

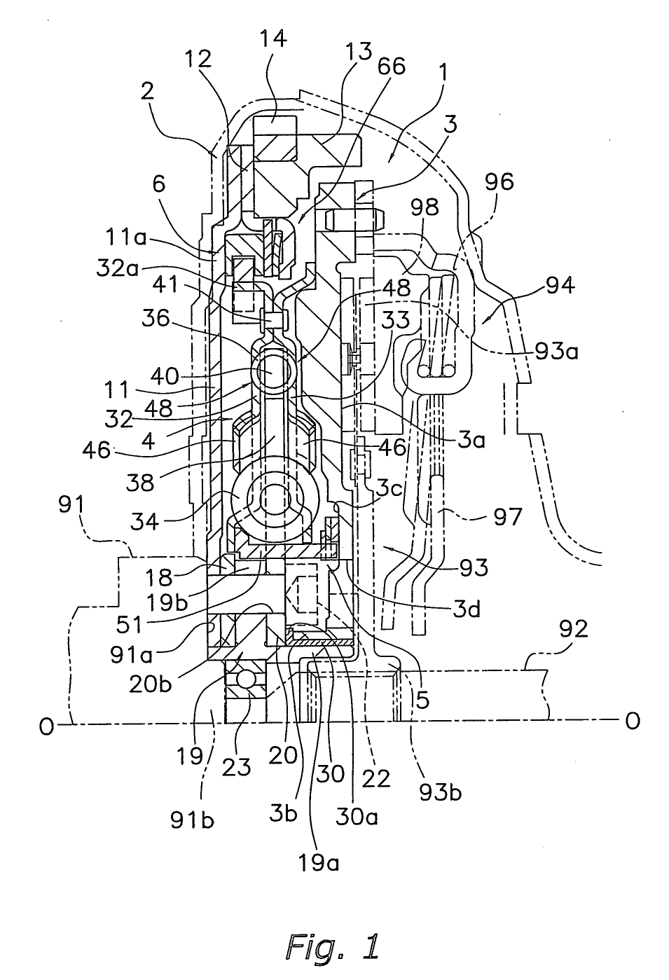

In FIG. 1, a dual-mass flywheel 1 in accordance with a preferred embodiment of the present invention is shown. The dual-mass flywheel 1 transmits torque from a crankshaft 91 on the engine side to an input shaft 92 on the transmission side by way of a clutch (a clutch disc assembly 93 and a clutch cover assembly 94). The dual-mass flywheel 1 has a damper function to absorb and to attenuate torsional vibrations. The dual-mass flywheel 1 principally has a first flywheel 2, a second flywheel 3, a damper mechanism 4 arranged between both the flywheels 2 and 3, a first friction generation mechanism 5, and a second friction generation mechanism 6.

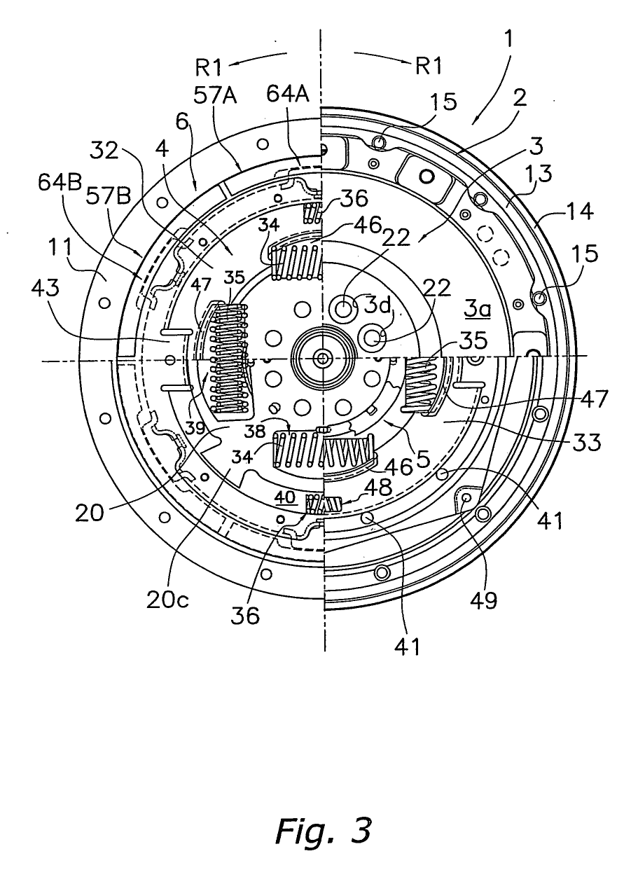

The line O-O in FIG. 1 is the axial line of rotation of the dual-mass flywheel 1 and the clutch. Further, the engine (not depicted) is disposed on the left-hand side of FIG. 1, and the transmission (not depicted) is disposed on the right-hand side. Hereinafter, the left-hand side in FIG. 1 will be referred to as the axial-direction engine side, and the right-hand side will be referred to as the axial-direction transmission side. The direction in which the arrow R1 points in FIG. 3 is the drive side (positive rotational direction), and the direction in which the arrow R2 points is the reverse drive side (negative rotational direction).

The actual numbers in the embodiments described below relate to an example and do not limit the present invention.

2) First Flywheel

The first flywheel 2 is fixed to a tip of the crankshaft 91. The first flywheel 2 ensures a large moment of inertia on the crankshaft 91 side. The first flywheel 2 principally has a flexible plate 11 and an inertia member 13.

The flexible plate 11 is a member that absorbs bending vibrations from the crankshaft 91 as well as transmitting the torque from the crankshaft 91 to the inertia member 13. Therefore, the flexible plate 11 has a higher rigidity in the rotational direction but has a lower rigidity in the axial and bending directions. Specifically, it is preferable that the rigidity in the axial direction of the flexible plate 11 is 3000 kg/mm or less, and is in the range between 600 kg/mm to 2200 kg/mm. The flexible plate 11 is a disc-like member formed with a central hole and made of sheet metal, for example. A radially inner end of the flexible plate 11 is fixed to the tip of the crankshaft 91 by a plurality of bolts 22. Bolt through-holes are formed in the flexible plate 11 in positions corresponding to the bolts 22. The bolts 22 are mounted on the crankshaft 91 from the axial-direction transmission side.

The inertia member 13 has a relatively thick block shape, and is fixed to the axial-direction transmission side on the radially outer edge of the flexible plate 11. The radially outermost portion of the flexible plate 11 is fixed to the inertia member 13 by a plurality of rivets 15 aligned in the circumferential direction. A ring gear 14 for engine startup is fixed to the radially outer surface of the inertia member 13. The first flywheel 2 may also be constructed as an integral member.

3) Second Flywheel

The second flywheel 3 is an annular, disc-like member located on an axially transmission-side of the first flywheel 2. The second flywheel 3 is formed with a clutch friction face 3a on the axial-direction transmission side. The clutch friction face 3a is an annular, flat surface, and is a portion that is engaged by the clutch disc assembly 93 described hereinafter. The second flywheel 3 further has a radially inner cylindrical portion 3b extending toward the engine the in the axial direction at the radially inner periphery. In addition, the second flywheel 3 is formed with through holes 3d arranged in the circumferential direction at the radially inner portion for allowing the bolts 22 to penetrate therethrough.

4) Damper Mechanism

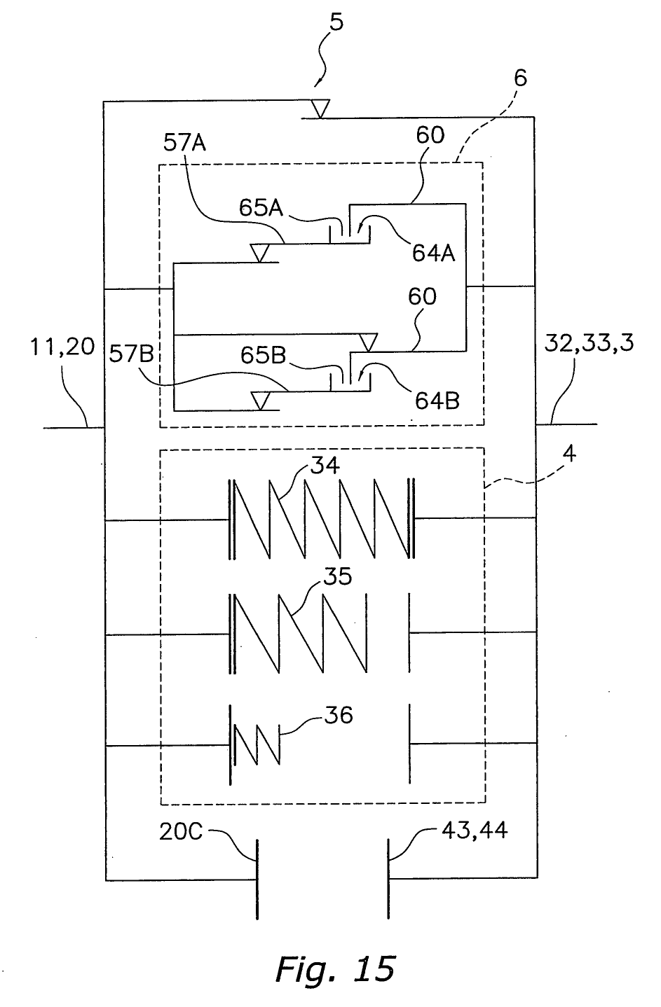

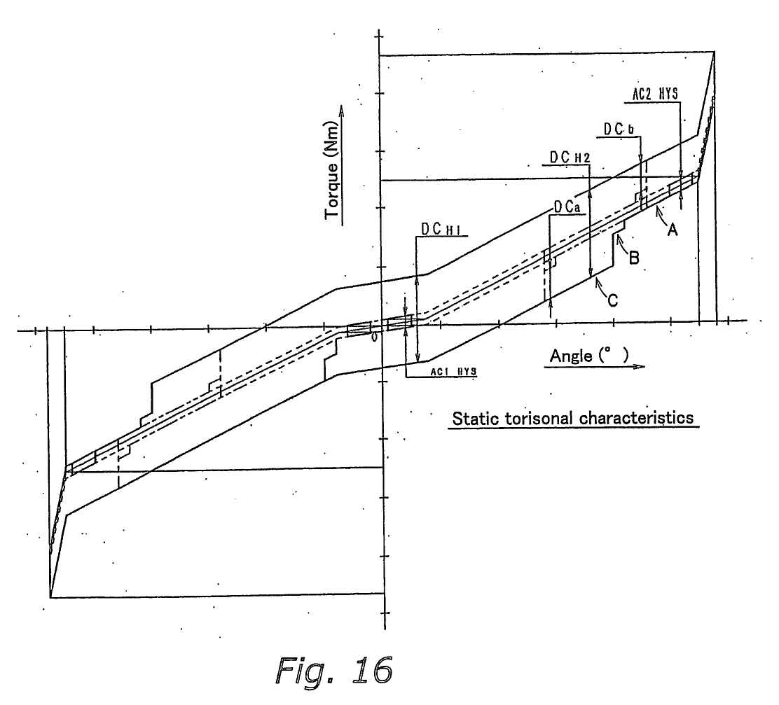

The damper mechanism 4 is described below. The damper mechanism 4 elastically engages the second flywheel 3 with the crankshaft 91 in the rotational direction. The second flywheel 3 is connected to the crankshaft 91 via the damper mechanism 4 so as to constitute a flywheel assembly (flywheel damper) with the damper mechanism 4. The damper mechanism 4 is composed of a plurality of coil springs 34, 35, and 36, a pair of output-side disk-like plates 32 and 33, and an input-side disk-like plate 20. The coil springs 34, 35, and 36 are disposed in parallel with the friction generation mechanisms 5 and 6 in the direction of rotation, as shown in the mechanical circuit diagram in FIG. 15.

The pair of output-side disk-like plates 32 and 33 is composed of a first plate 32 on the axial-direction engine side, and a second plate 33 on the axial-direction transmission side. Both plates 32 and 33 are disk-like members, and are disposed to maintain a certain distance therebetween in the axial direction. A plurality of windows 46 and 47 aligned in the circumferential direction is respectively formed in each of the plates 32 and 33. The windows 46 and 47 are structures that support the coil springs 34 and 35 in the axial direction and in the direction of rotation, and have upwardly cut portions that hold the coil springs 34 and 35 in the axial direction and make contact at both ends in the circumferential direction thereof. The number of each of the windows 46 and 47 are two and they are alternately arranged in the circumferential direction (arranged in the same radial position). Each of the plates 32 and 33 is formed with a plurality of third windows 48 arranged in the circumferential direction. The third windows 48 are formed in the positions radially opposing to each other, more specifically radially outward of the first windows 46 to support the third coil springs 36 (later described) in the axial and rotational directions.

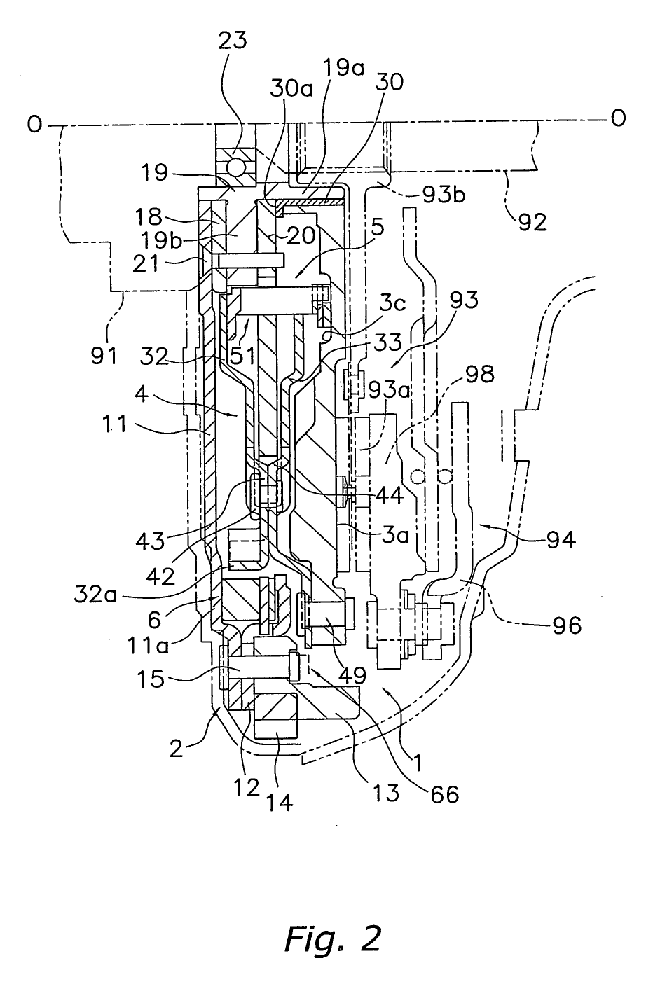

The first plate 32 and the second plate 33 have radially inner portions maintaining a certain gap in the axial direction and radially outer portions close to each other to be fixed by rivets 41 and 42. The first rivets 41 are arranged in the circumferential direction. The second rivets 42 couple cut-and-bent abutting portions 43 and 44 formed on the first plate 32 and the second plate 33. The cut-and-bent abutting portions 43 and 44 are arranged in positions radially opposing to each other, more specifically are arranged radially outward of the second window 47. As shown in FIG. 2, axial positions of the cut-and-bent abutting portions 43 and 44 are the same with that of the input-side disc-like plate 20.

The second plate 33 has a radially outer portion fixed to a radially outer portion of the second flywheel 3 via a plurality of rivets 49.

The input-side disk-like plate 20 is a disk-like member disposed axially between the output-side disk-like plates 32 and 33. The input-side disc-like plate 20 is formed with first window holes 38 corresponding to the first windows 46, and second window holes 39 corresponding to the second windows 47. In addition, each of the first and second window holes 38 and 39 has a straight radially inner periphery whose intermediate portion in the rotational direction has cutouts 38a and 39a dented radially inward. The input-side disc-like plate 20 is, as shown in FIG. 1, further formed with a central hole 20a and a plurality of bolt through holes 20b around the central hole 20a. Circumferentially between each of the window holes 38 and 39 of the radially outer periphery direction are formed projections 20c projecting radially outward. The projections 20c are positioned apart from the cut-and-bent abutting portions 43 and 44 of the output-side disc-like plates 32 and 33 and the third coil springs 36 in the rotational direction so as to be brought into contact with them when approaching them in the rotation direction. In other words, the projections 20c and the cut-and-bent abutting portions 43 and 44 constitute a stopper mechanism for the whole of the damper mechanism 4. Spaces between the projections 20c in the rotational direction serve as third window holes 40 to accommodate the third coil springs 36. The input-side disc-like plate 20 is formed with holes 20d at a plurality of positions (four positions in this embodiment) in the circumferential direction. The hole 20d is substantially circular but slightly elongated in the radial direction. A rotational position of the hole 20d is between the window holes 38 and 39 in the rotational direction, and a radial position of the hole 20d is the same as those of the cutout 38a and 39a.

The input-side disc-like plate 20 is fixed to the crankshaft 91 with the flexible plate 11, a reinforcement member 18 and a support member 19 via the bolts 22. A radially inner portion of the flexible plate 11 is in contact with an axial-direction transmission side face of an apical surface 91a of the crankshaft 91. The reinforcement member 18 is a disc-like member and is contact with an axial-direction transmission side face of the radially inner portion of the flexible plate 11. The support member 19 is composed of a cylindrical portion 19a and a disc portion 19b extending radially from an outer surface of the cylindrical portion 19a. The disc portion 19b is in contact with an axial-direction transmission side face of the reinforcement member 18. An inner surface of the cylindrical portion 19a is in contact with an outer surface of a cylindrical projection 91b formed at the center of the tip of the crankshaft 91 for centering. The inner circumferential surface of the flexible plate 11 and the inner circumferential surface of the reinforcement member 18 are in contact with the outer surface of the cylindrical portion 19a on the axial-direction engine side for centering. The inner circumferential surface of the input-side disc-like plate 20 is in contact with the outer surface of the cylindrical portion 19a at a base portion on the axial-direction transmission side for centering. To the inner surface of the cylindrical portion 19a is attached a bearing 23, which rotationally supports the tip of the input shaft 92 of the transmission. The members 11, 18, 19, and 20 are fastened with each other by screws 21.

As described above, the support member 19 is positioned relative to the crankshaft 91 in the radial direction for fixation, and in turn positions the first flywheel 2 and the second flywheel 3 in the radial direction. Accordingly, since one component has a plurality of functions, the number of the components is decreased and the cost is lowered.

An inner surface of the cylindrical portion 3b of the second flywheel 3 is supported by the outer surface of the cylindrical portion 19a of the support member 19 via a bush 30. As a result, the second flywheel 3 is centered by the support member 19 relative to the first flywheel 2 and the crankshaft 91. The bush 30 further has a thrust portion 30a located between the radially inner portion of the input-side disc-like plate 20 and the tip of the cylindrical portion 3b of the second flywheel 3. Accordingly, a thrust load from the second flywheel 3 is received via the thrust portion 30a by the members 11, 18, 19, and 20, which are arranged in the axial direction. More specifically, the thrust portion 30a of the bush 30 is supported by the radially inner portion of the input-side disc-like plate 20 so as to function as a thrust bearing to bear the axial load from the second flywheel 3. Since the radially inner portion of the input-side disc-like plate 20 is flat so that flatness is improved, load generated in the thrust bearing is stable. Furthermore, since the radially inner portion of the input-side disc-like plate 20 is flat, length of the thrust bearing portion can be longer. As a result, the hysteresis torque is stable. Moreover, since the radially inner portion of the input-side disc-like plate 20 is in contact with the disc portion 19b of the support member 19 with no clearance in the axial direction, the radially inner portion of the input-side disc-like plate 20 has a high rigidity.

The first coil spring 34 is positioned in the first window hole 38 and the first window 46. Rotational ends of the first coil spring 34 are in contact with or close to rotational ends of the first window hole 38 and the first window 46.

The second coil spring 35 is disposed in the second window hole 39 and the second window 47. The second coil spring 35 is made of a spring assembly in which a large and a small spring are combined, and is higher than the first coil spring 34 in rigidity. Rotational ends of the second coil spring 35 are in contact with or close to rotational ends of the second window 47, but are apart from the rotational ends of the second window hole 39 with a predetermined angle (4 degrees in this embodiment).

The third coil spring 36 is disposed in the third window hole 40 and the third window 48. The third coil spring 36 is smaller than the first coil spring 34 and the second coil spring 35, and is disposed radially outward of the first coil spring 34 and the second coil spring 35. The third coil spring 36 is higher than the first coil spring 34 or the second coil spring 35 in rigidity.

5) Friction Generation Mechanisms

5-1) First Friction Generation Mechanism 5

The first friction generation mechanism 5 is a mechanism for operating between the input-side disc-like plate 20 and the output-side disc-like plates 32 and 33 of the damper mechanism 4 in the rotational direction in parallel with the coil springs 34, 35, and 36, and generates a prescribed frictional resistance (hysteresis torque) when the crankshaft 91 and the second flywheel 3 rotate relative to each other. The first friction generation mechanism 5 generates a constant friction over an entire range of operating angles of the damper mechanism 4, and is designed to generate a comparatively small friction.

The first friction generation mechanism 5 is located radially inward of the damper mechanism 4, and between the first plate 32 and the second flywheel 3 in the axial direction as well. The first friction generation mechanism 5 is composed of a first friction member 51, a second friction member 52, a cone spring 53, and a washer 54.

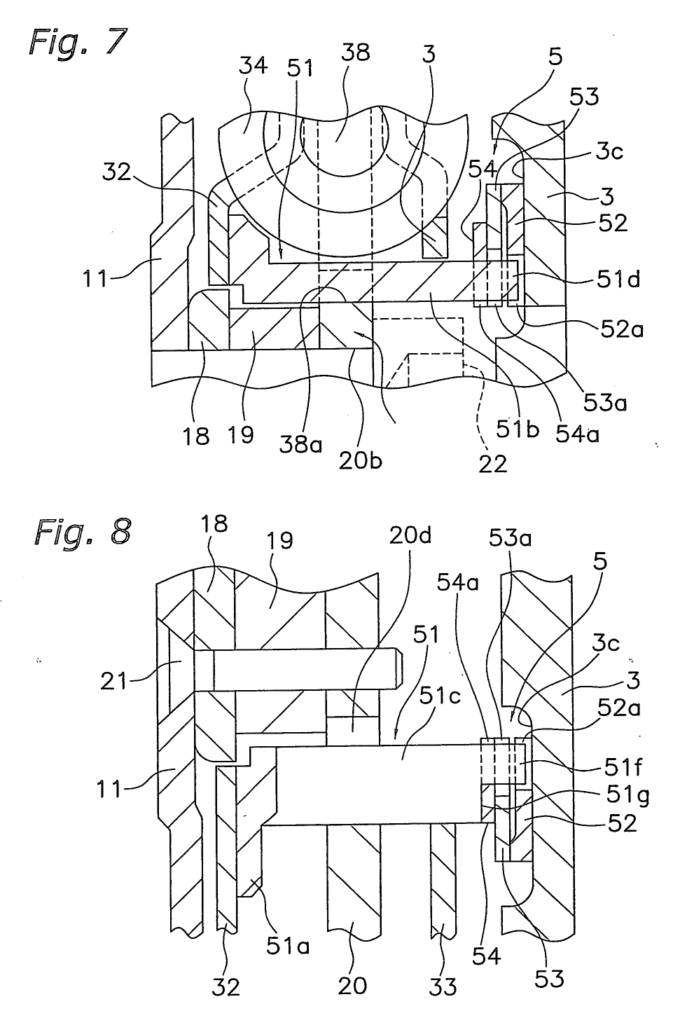

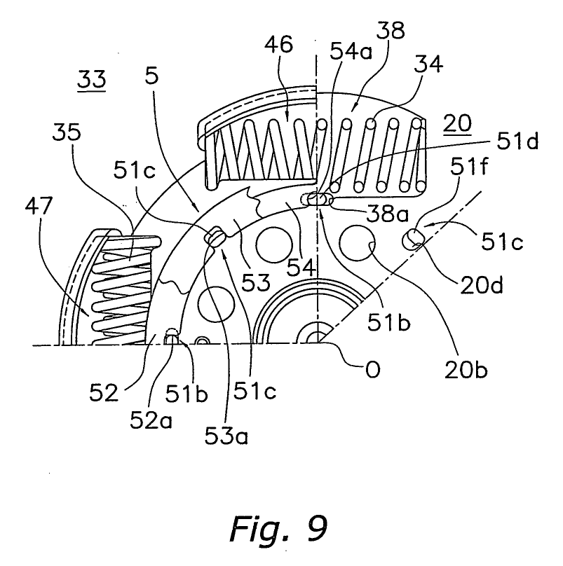

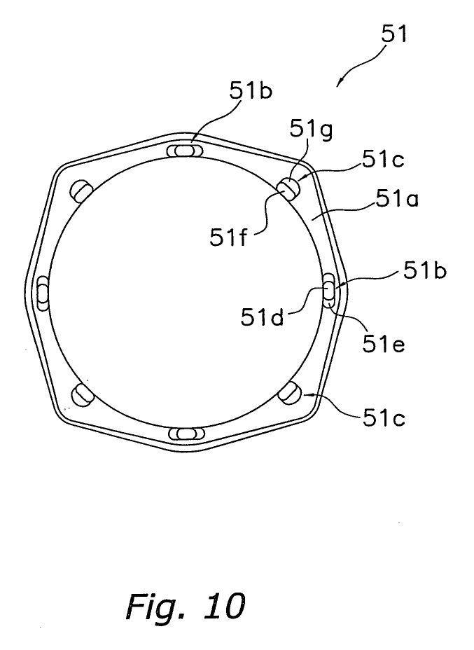

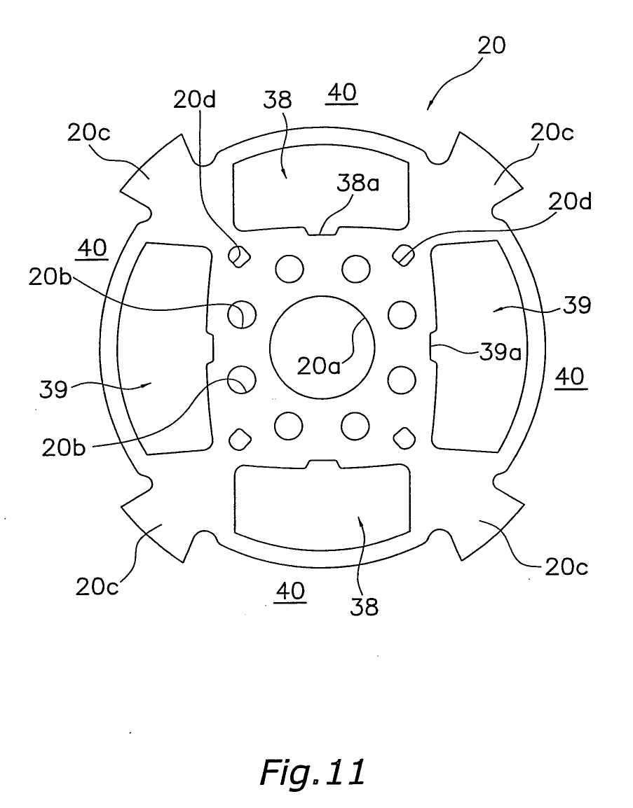

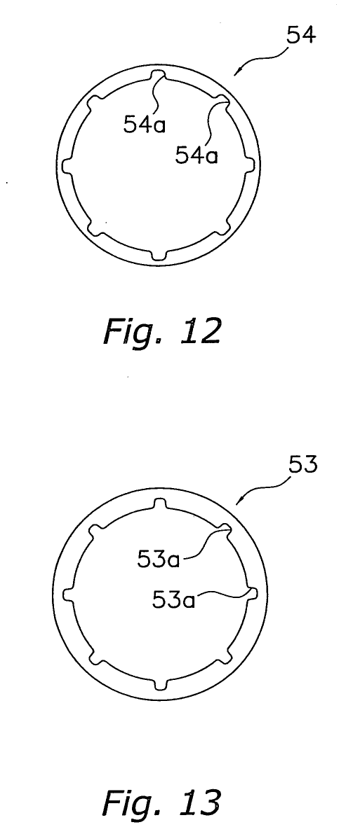

The first friction member 51 is a member that rotates integrally with the input-side disc-like plate 20 to slide against the first plate 32 in the rotational direction. As shown in FIGS. 7 to 10, the first friction member 51 is formed with an annular portion 51a, and first and second engagement portions 51b and 51c extending toward the transmission in the axial direction from the annular portion 51a. The annular portion 51a is in contact with a radially inner portion of the first plate 32 so as to be slidable in the rotational direction. The first engagement portions 51b and the second engagement portions 51c are alternately located in the rotational direction. The first engagement portion 51b is elongated in the rotational direction and is engaged with the radially inner cutouts 38a and 39a of the window holes 38 and 39 of the input-side disc-like plate 20. The second engagement portion 51c has a shape of being slightly elongated in the radial direction and is engaged with the hole 20d of the input-side disc-like plate 20. Accordingly, the first friction member 51 can move in the axial direction relative to the input-side disc-like plate 20 but cannot rotate relative to the plate 20.

At a rotational middle position of the axial tip of the first engagement portion 51b is formed a first projection 51d further extending in the axial direction, thereby forming first axial faces 51e on the opposite sides of the first projection 51d in the rotational direction. In addition, at a radially inner position of the second engagement portion 51c is formed a second projection 51f further extending in the axial direction, thereby forming a second axial-side face 51g at a radially outer portion of the second projection 51f.

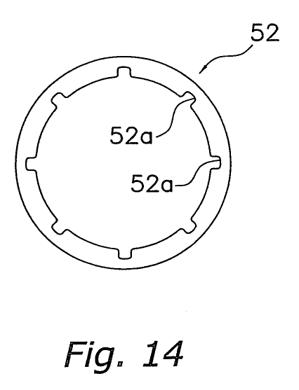

The second friction member 52 is a member that rotates integrally with the input-side disc-like plate 20 to slide against the second flywheel 3 in the rotational direction. The second friction member 52 is, as shown in FIG. 14, an annular member which is in contact with a second friction face 3c of a radially inner portion of the second flywheel 3 so as to slide in the rotational direction. The second friction face 3c is an annular, flat face which is dented toward the transmission in the axial direction compared to the other portion of the second flywheel 3.

The second friction member 52 is formed with a plurality of cutouts 52a arranged in the rotational direction at the radially inner periphery. Into the cutouts 52a, the first projection 51d of the first engagement portion 51b and the second projection 51f of the second engagement portion 51c are fitted. Accordingly, the second friction member 52 can move in the axial direction but cannot rotate relative to the first friction member 51.

The cone spring 53 is a member disposed between the first friction member 51 and the second friction member 52 in the axial direction to urge both members in the axial direction for separation. The cone spring 53 is, as shown in FIG. 13, a cone or disc spring which is formed with a plurality of cutout 53a at the radially inner periphery. Into the cutouts 53a, the first projection 51d of the first engagement portion 51b and the second projection 51f of the second engagement portion 51c are fitted. Accordingly, the cone spring 53 can move relative to the first friction member 51 in the axial direction but cannot rotate relative to the member 51.

The washer 54 is a member for reliably transmitting the load of the cone spring 53 to the first friction member 51. The washer 54 is, as shown in FIG. 14, an annular member which is formed with a plurality of cutouts 54a arranged in the circumferential direction at the radially inner periphery. Into the cutouts 54a, the first projection 51d of the first engagement portion 51b and the second projection 51f of the second engagement portion 51c are fitted. As a result, the washer 54 can move in the axial direction relative to the first friction member 51 but cannot rotate relative to the member 51. The washer 54 is seated on the first axial face 51e of the first engagement portion 51b and the second axial-side face 51g of the second engagement portion 51c. The cone spring 53 has a radially inner portion supported by the washer 54 and a radially outer portion supported by the second friction member 52.

5-2) Second Friction Generation Mechanism 6

The second friction generation mechanism 6 operates in parallel with the coil springs 34, 35, and 36 between the output-side disk-like plates 32 and 33 and the input-side disk-like plate 20 of the damper mechanism 4 in the rotational direction, and generates a prescribed frictional resistance (hysteresis torque) when the crankshaft 91 rotates in relation to the second flywheel 3. The second friction generation mechanism 6 generates a constant friction over an entire range of operating angles of the damper mechanism 4, and is designed to generate comparatively large friction. In this embodiment, hysteresis torque generated by the second friction generation mechanism 6 is five to ten times as much as that generated by the first friction generation mechanism 5.

The second friction generation mechanism 6 is composed of a plurality of washers in contact with each other. The second friction generation mechanism 6 is disposed in the space formed in the axial direction between a second disk-like plate 12 and an annular portion 11a, which is a radially outer portion of the flexible plate 11. The washers in the second friction generation mechanism 6 are disposed adjacent to the radially inner side of the inertia member 13 and the rivets 15.

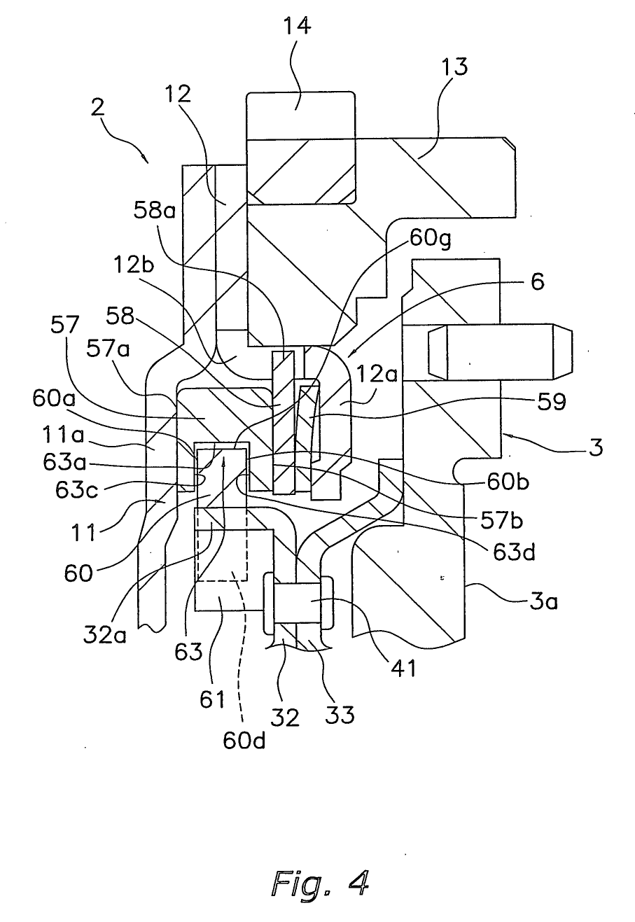

The second friction generation mechanism 6 has, in order from the flexible plate 11 toward a facing portion 12a of the second disc-like plate 12, a friction washer 57, an input-side friction plate 58, and a cone spring 59, as shown in FIG. 4. Thus, the flexible plate 11 has a function of accommodating the second friction generation mechanism 6, so the number of components is reduced and the structure is simplified compared to conventional structures.

The cone spring 59 imparts a load in the axial direction to friction surfaces, and is interposed and compressed between the facing portion 12a and the input-side friction plate 58. Therefore, the cone spring 59 exerts an urging force on both members in the axial direction. Pawls 58a formed on a radially outer edge of the input-side friction plate 58 are engaged with axially extending cutaway areas 12b of the second disc-like plate 12. Thus, the input-side friction plate 58 is prevented from rotating relative to the second disc-like plate 12 by this engagement, but is movable in the axial direction.

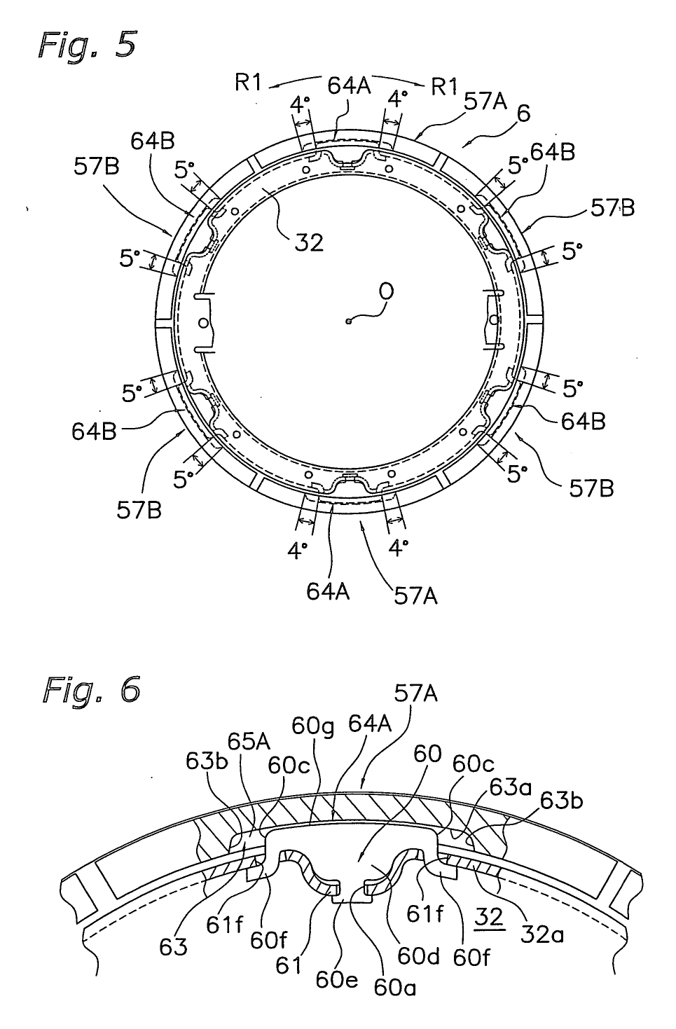

As shown in FIG. 5, the friction washers 57 are composed of a plurality of members aligned and disposed in the direction of rotation, and each of these extends in the form of an arc. In this embodiment, there are a total of six friction washers 57. The friction washers 57 are interposed between the input-side friction plate 58 and the annular portion 11a as the radially outer portion of the flexible plate 11. In other words, an axial-direction engine side surface 57a of the friction washers 57 makes contact in a slidable manner with the axial-direction transmission side surface of the flexible plate 11, and an axial-direction transmission side surface 57b of the friction washer 57 makes contact in a slidable manner with the axial-direction engine side surface of the input-side friction plate 58. A concavity 63 is formed on the radially inner surface of the friction washer 57, as shown in FIG. 6. The concavity 63 is formed roughly in the rotation direction of the friction washer 57, and more specifically, has a bottom surface 63a extending in the direction of rotation, and rotational-direction end faces 63b extending from both ends thereof in a roughly radially inward direction (roughly at a right angle from the bottom surface 63a). The concavity 63 is formed in the axially middle portion on the radially inner surface of the friction washer 57 so as to have axial-direction end faces 63c and 63d, thereby forming opposite sides in the axial direction.

Frictional engagement members 60 are disposed on the radially inner side of the friction washers 57, or, more specifically, within the concavities 63. The radially outer portion of the frictional engagement member 60 is disposed within the concavity 63 of the friction washer 57. Both the friction washers 57 and the frictional engagement members 60 are made of resin.

An engagement portion 64 constituted by the frictional engagement member 60 and the concavity 63 of friction washer 57 is described below. The frictional engagement member 60 has axial-direction end faces 60a and 60b, and rotational-direction end faces 60c. A radially outer surface 60g of the frictional engagement member 60 is adjacent to the bottom surface 63a in the concavity 63, and a rotational-direction gap 65 (corresponding to 65A in FIG. 6) with a certain angle is obtained respectively between the end face 60c and the rotational-direction end face 63b in each rotational direction. The total of both angles is a prescribed angle whose size allows the friction washer 57 to rotate relative to the frictional engagement member 60. This angle is preferably within a range that is equal to or slightly exceeds the damper operation angle created by small torsional vibrations caused by combustion fluctuations in the engine. In this embodiment, the frictional engagement members 60 are disposed at the center of the direction of rotation of concavities 63 in the neutral state shown in FIG. 6. Therefore, the sizes of the gaps on each side of each frictional engagement member 60 in the direction of rotation are the same.

The frictional engagement members 60 are engaged with the first plate 32 to rotate integrally and in a manner that allows movement in the axial direction. More specifically, an annular wall 32a extending toward the engine in the axial direction is formed on the radially outer edge of the first plate 32, and concavities 61 indented on the internal side in the radial direction are formed on the annular wall 32a corresponding to the frictional engagement members 60. In addition, the concavity 61 is formed with a first slit 61a penetrating in the radial direction at the center in the rotational direction and second slits 61b penetrating in the radial direction at opposite sides thereof. The frictional engagement member 60 has a first leg portion 60e that extends inward from the external side in the radial direction in the first slit 61a, extends separately outward in the direction of rotation, and makes contact with the radially inner surface of the annular wall 32a, and a pair of second leg portions 60f that extends inward from the external side in the radial direction in the second slits 61b, extends outward in the direction of rotation, and makes contact with the radially inner surface of the annular wall 32a. As a result, the frictional engagement member 60 does not move relative to the annular wall 32a to the outside in the radial direction. In addition, the frictional engagement member 60 has a convexity 60d that extends inward in the radial direction, and is engaged in the direction of rotation with the concavity 61 in the annular wall 32a. The frictional engagement members 60 are thereby integrally rotated as convexities with the first plate 32.

In addition, the frictional engagement members 60 are detachably attached to the first plate 32 in the axial direction.

The length in the axial direction of the frictional engagement member 60 is less than the length in the axial direction of the concavity 63 (that is to say, the space between the axial-direction end faces 63c and 63d of the concavity 63 has a greater length than the space between the axial-direction end faces 60a and 60b of the frictional engagement member 60). Thus, the frictional engagement members 60 are capable of moving relative to the friction washers 57 in the axial direction. A gap in the radial direction is provided in the space between the radially outer surface 60g of the frictional engagement member 60 and the bottom surface 63a of the concavity 63, so the frictional engagement member 60 is capable of tilting with respect to the friction washer 57 within a prescribed angle.

As described above, the friction washers 57 are frictionally engaged with the flexible plate 11 and the input-side friction plate 58, which are input side members, in the rotational direction, and also are engaged with the frictional engagement members 60 in a manner that allows torque to be transmitted by way of the rotational direction gap 65 of the engagement portion 64. The frictional engagement members 60 can also integrally rotate with the first plate 32, and move relative to the first plate 32 in the axial direction.

Next, the relationship between the friction washer 57 and the frictional engagement member 60 is described in greater detail. The widths in the direction of rotation (the angles in the direction of rotation) of the frictional engagement members 60 are all the same, but some of the widths in the direction of rotation (the angles in the direction of rotation) of the concavities 63 may be different. That is to say, there are at least two types of friction washers 57 with differing widths in the direction of rotation of the concavities 63. In this embodiment, these are composed of two first friction washers 57A that face each other in the up and down directions of FIG. 5, and four second friction washers 57B that face each other in the left and right directions. The first friction washer 57A and the second friction washer 57B have roughly the same shape, and are made of the same material. The only point in which these differ is the width in the direction of rotation (the angles in the direction of rotation) of the rotational direction gap of the concavity 63. More specifically, the width in the direction of rotation of the concavities 63 of the second friction washer 57B is larger than the width in the direction of rotation of the concavity 63 of the first friction washer 57A. As a result, the second rotational direction gap 65B of a second engagement portion 64B in the second friction washer 57B is larger than the first rotational direction gap 65A of a first engagement portion 64A in the first friction washer 57A. In this embodiment, the former is preferably 10 degrees and the latter is 8 degrees, and the difference is 2 degrees, for example.

Both edges of the first friction washer 57A and the second friction washer 57B in the direction of rotation are adjacent to each other. The angle between the edges in the direction of rotation is set to a value that is greater than the difference (2 degrees, for example) between the second rotational direction gap 65B in the second friction washer 57B and the first rotational direction gap 65A in the first friction washer 57A.

6) Clutch Disc Assembly

The clutch disc assembly 93 of the clutch has friction facings 93a that are disposed adjacent to the clutch friction face 3a of the second flywheel 3, and a hub 93b that is spline-engaged with the transmission input shaft 92.

7) Clutch Cover Assembly

The clutch cover assembly 94 includes a clutch cover 96, a diaphragm spring 97, and a pressure plate 98. The clutch cover 96 is an annular, disc-like member fixed to the second flywheel 3. The pressure plate 98 is an annular member having a pressing surface adjacent to the friction facings 93a and integrally rotatable with the clutch cover 96. The diaphragm spring 97 is a member for elastically urging the pressure plate 98 toward the second flywheel as supported on the clutch cover 96. When a release device (not shown) pushes the radially inner end of the diaphragm spring 97 toward the engine in the axial direction, the diaphragm spring 97 releases its pressure toward the pressure plate 98.

(2) Operation

1) Torque Transmission

In this dual-mass flywheel 1, the torque from the engine crankshaft 91 is transmitted to the second flywheel 3 via the damper mechanism 4. In this damper mechanism 4, the torque is transmitted in order from the input-side disk-like plate 20, the coil springs 34 to 36, and the output-side disk-like plates 32 and 33. In addition, the torque is transmitted from the dual-mass flywheel 1 to the clutch disc assembly 93 with the clutch in an engagement state, and is finally output to the input shaft 92.

2) Absorption and Attenuation of Torsional Vibrations

When combustion fluctuations from the engine are input to the dual-mass flywheel 1, the output-side disk-like plates 32 and 33 rotate relative to the input-side disk-like plate 20 in the damper mechanism 4, and the coil springs 34 to 36 are compressed in parallel with each other therebetween. In addition, the first and second friction generation mechanisms 5 and 6 generate the prescribed hysteresis torque. The torsional vibration is absorbed and attenuated by the above-described operation.

Next, referring to a torsion characteristics diagram in FIG. 16, the operation of the damper mechanism 4 is described. In an area in which the torsional angle is small (near the angle zero), only the first coil springs 34 are compressed to generate relatively low rigidity characteristics. When the torsional angle increases, the first coil springs 34 and the second coil springs 35 are compressed in parallel with each other to generate relatively high rigidity characteristics. When the torsional angle further increases, the first coil springs 34, the second coil springs 35, and the third coil springs 36 are compressed in parallel with each other to generate the highest rigidity characteristics at both ends in the torsion characteristics. The first friction generation mechanism 5 operates over the whole range of the torsional angle. It should be noted that the second friction generation mechanism 6 does not operate until the predetermined angle after the orientation of the torsional operation is changed at both the ends of the torsional angle.

Next, the operation performed when the friction washers 57 are driven by the frictional engagement members 60 is described. The operation in which the frictional engagement members 60 are twisted from the neutral state in the rotation direction RI in relation to the friction washers 57 is described.

When the torsion angle increases, the frictional engagement member 60 in the first friction washer 57A eventually makes contact with the rotational-direction end face 63b on the side in the rotational direction R1 of the concavity 63 of the first friction washer 57A. At this time, the frictional engagement member 60 in the second friction washer 57B have a rotational direction gap (which is one-half of the difference between the second rotation direction gap 65B of the second friction washers 57B and the first rotational direction gap 65A of the first friction washers 57A, and is 1 degree in this embodiment) in the rotational-direction end face 63b of the concavity 63 of the second friction washer 57B in the rotational direction R1.

When the torsion angle further increases, the frictional engagement member 60 drives the first friction washers 57A, and causes them to slide in relation to the flexible plate 11 and the input-side friction plate 58. At this time, the first friction washer 57A approaches the second friction washer 57B in the rotational direction R1, but the edge portions of both of these do not make contact.

When the torsion angle finally realizes the prescribed magnitude, the frictional engagement member 60 makes contact with the rotational-direction end face 63b of the concavity 63 of the second friction washer 57B. After this, the frictional engagement members 60 drive both the first and second friction washers 57A and 57B, causing them to slide in relation to the flexible plate 11 and the input-side friction plate 58.

In summary, driving the friction washer 57 with the aid of the first plate 32 yields an area in which a constant number of plates is driven to generate an intermediate frictional resistance in the torsion characteristics before the start of the large frictional resistance area in which all of the plates are driven.

2-1) Small Torsional Vibrations

Next, the operation of the damper mechanism 4 when small torsional vibrations caused by combustion fluctuations in the engine are inputted to the dual-mass flywheel 1 is described below with reference to the mechanical circuit diagram in FIG. 15 and the diagrams of torsional characteristics in FIGS. 16 to 19.

When small torsional vibrations are inputted, the input-side disk-like plate 20 in the second friction generation mechanism 6 rotates relative to the friction washers 57 in the rotational direction gaps 65 between the concavities 63 and the frictional engagement members 60 (the convex portions). In other words, the friction washers 57 are not driven with the first plate 32, and the friction washers 57 therefore do not rotate in relation to the member on the input side. As a result, high hysteresis torque is not generated for small torsional vibrations. That is, although the coil springs 34 and 35 operate at “DCa”, for example, in the diagram of torsional characteristics in FIG. 16, a slippage does not occur in the second friction generation mechanism 6. That is to say, only a hysteresis torque that is much smaller than normal hysteresis torque can be obtained in a prescribed range of torsion angles. Thus, the vibration and noise level can be considerably reduced because a very narrow rotational direction gap is provided in which the second friction generation mechanism 6 does not operate in the prescribed angle range.

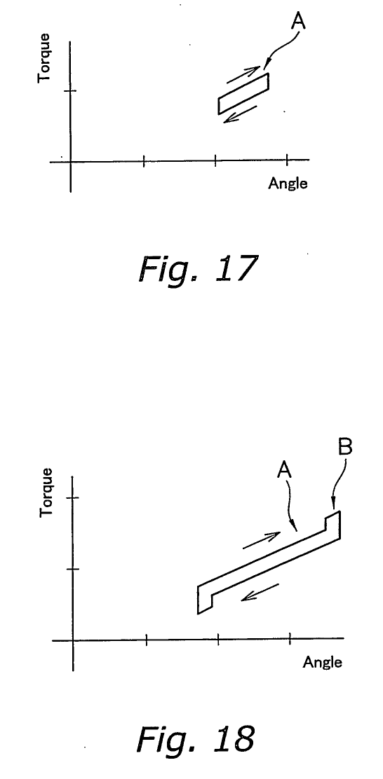

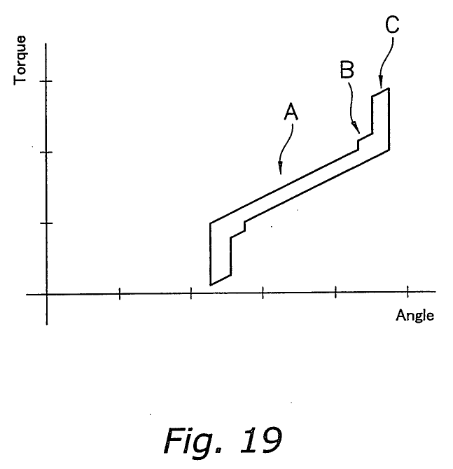

As a result, when the operating angle of the torsional vibration is less than the angle (8 degrees, for example) of the first rotational direction gaps 65A of the first engagement portions 64A of the first friction washers 57A, large frictional resistance (high hysteresis torque) is not generated at all and only area A of low frictional resistance is obtained in the second stage of torsion characteristics, as shown in FIG. 17. Moreover, when the operating angle of the torsional vibration is equal to or greater than the angle (8 degrees, for example) of the first rotational direction gaps 65A of the first engagement portions 64A of the first friction washers 57A, and is equal to or less than the angle (10 degrees, for example) of the second rotational direction gaps 65B of the second engagement portions 64B of the second friction washers 57B, the areas B of intermediate frictional resistance are generated on the edges of the area A of low frictional resistance, as shown in FIG. 18. When the operating angle of the torsional vibration is equal to or less than the angle (10 degrees, for example) of the second rotational direction gaps 65B of the second engagement portions 64B of the second friction washers 57B, the area B of intermediate frictional resistance and the area C in which a certain large frictional resistance is generated are respectively obtained on both edges of the area A of low frictional resistance, as shown in FIG. 19.

2-2) Operation When the Wide-Angle Torsional Vibrations are Input

The operation of the second friction generation mechanism 6 is described below for the case in which large torsional vibrations are inputted. In the second friction generation mechanism 6, the friction washers 57 integrally rotate with the frictional engagement members 60 and the first plate 32, and also rotate relative to the flexible plate 11 and the input-side friction plate 58. As a result, the friction washers 57 slide against the flexible plate 11 and the input-side friction plate 58 to generate frictional resistance. As described previously, when the torsional angle of the torsional vibration is large, the friction washers 57 slide against the flexible plate 11 and the input-side friction plate 58. As a result, a frictional resistance with a constant magnitude is obtained over the entire range of torsional characteristics.

Here, the operation in the edge portion (position in which the direction of the vibration changes) of the torsion angle is described. At the right-hand edge of the torsion characteristic line chart of FIG. 16, the friction washers 57 shift toward their most rotational direction R2 position in relation to the first plate 32. When the first plate 32 twists from this state toward the rotational direction R2, the friction washers 57 rotate in relation to the first plate 32 across the entire angle of the rotational direction gaps 65 of the frictional engagement members (the convexity) 60 and the concavities 63. In this interval, area A (8 degrees, for example) of low frictional resistance can be obtained because the friction washers 57 do not slide against the member on the input side. Next, when the first rotational direction gaps 65A of the first engagement portions 64A of the first friction washers 57A are no longer present, the first plate 32 drives the first friction washers 57A. Then, the first friction washers 57A rotate relative to the flexible plate 11 and the input-side friction plate 58. As a result, area B of intermediate frictional resistance (2 degrees, for instance) is generated as described above. When the second rotational direction gaps 65B of the second engagement portions 64B of the second friction washers 57B are no longer present, the first plate 32 subsequently drives the second friction washers 57B. Then, the second friction washers 57B rotate relative to the flexible plate 11 and the input-side friction plate 58. Area C of comparatively large frictional resistance is generated because both the first friction washers 57A and the second friction washers 57B slide together at this time. It is noted that hysteresis torque generated by the first friction washers 57A is smaller than that of the second friction washers 57B, about one-half in this embodiment.

As described above, area B of intermediate frictional resistance is provided at an early stage when a large frictional resistance is generated. A barrier of high hysteresis torque does not exist when a large frictional resistance is generated because the buildup of large frictional resistance is graduated in this manner. As a result, the knocking sound of the pawls when high hysteresis torque is generated decreases in a frictional resistance generation mechanism with a very narrow rotational direction gap for absorbing small torsional vibrations.

In particular, the number of types of frictional members can be kept low in the present invention because a single type of friction washer 57 is used to generate intermediate frictional resistance. The friction washer 57 is also a simple structure that extends in the form of an arc. Furthermore, through-holes in the axial direction are not formed in the friction washers 57, and thus, manufacturing costs can be kept low.

2-3) Operation When the Small-Angle Torsional Vibrations are Input

Next, the operation of the second friction generation mechanism 6 is described for a case in which small torsional vibrations caused by combustion fluctuations in the engine are input to the flywheel damper.

When small torsional vibrations are inputted in the second friction generation mechanism 6, the frictional engagement members 60 rotate relative to the friction washers 57 in the very narrow rotational direction gaps 65. In other words, the friction washers 57 are not driven by the frictional engagement members 60, and the friction washers 57 therefore do not rotate in relation to the input side member. As a result, high hysteresis torque is not generated in response to the small torsional vibrations. That is to say, only a hysteresis torque that is much smaller than normal hysteresis torque can be obtained in the prescribed range of torsion angles. Thus, since a very narrow rotational direction gap is provided in which the second generation mechanism 6 does not operate in the prescribed angle range, the vibration and noise level in the torsion characteristics can be considerably reduced.

(3) Effects

3-1) Effects of the First Friction Generation Mechanism 5

Since the first friction generation mechanism 5 makes use of a part of the second flywheel 3 as a frictional face, it is possible to enlarge an area of the sliding face. More specifically, since the second friction member 52 is urged by the cone spring 53 against the second flywheel 3, it is possible to enlarge the area of the sliding face. As a result, the pressure against the sliding face is lowered, thereby extending a life of the first friction generation mechanism 5.

The radially outer portion of the second friction member 52 and the radially inner portions of the first and second coil springs 34 and 35 are overlapped in the axial direction, and the radial position of the radially outer periphery of the second friction member 52 is radially outward of the radial positions of the radially inner peripheries of the first and second coil springs 34 and 35. Accordingly, although the second friction member 52 and the first and second coil springs 34 and 35 are very close to each other in the radial direction, the second friction generation mechanism 6 can ensure enough frictional face.

The radially outer portion of the annular portion 51a of the first friction member 51 and the radially inner portions of the first and second coil springs 34 and 35 are overlapped in the axial direction, and the radial position of the radially outer periphery of the annular portion 51a is radially outward of the radial positions of the radially inner peripheries of the first and second coil springs 34 and 35. As a result, although the annular portion 51a and the first and second coil springs 34 and 35 are very close to each other in the radial direction, the second friction generation mechanism 6 can ensure enough frictional face.

Only the first friction member 51 is unrotatably engaged with the input-side disc-like plate 20, and the first friction member 51 and the second friction member 52 are unrotatably engaged with each other. As a result, it is unnecessary to engage the input-side disc-like plate 20 with the second friction member 52, thereby realizing a simple structure.

The first friction member 51 has the annular portion 51a slidably in contact with the first plate 32 in the rotational direction, and the engagement portions 51b and 51c extending from the annular portion 51a in the axial direction and engaged with the input-side disc-like plate 20 such that the first friction member 51 can move in the axial direction but cannot rotate relative to the plate 20. The second friction member 52 is formed with the cutouts 52a engaged with the engagement portions 51b and 51c such that the second friction member 52 can move in the axial direction but cannot rotate relative to the member 51. Accordingly, since the first friction member 51 is formed with the engagement portions 51b and 51c extending in the axial direction, it is possible to realize easily a structure in which the annular portion 51a of the first friction member 51 and the second friction member 52 are apart from each other in the axial direction.

The cone spring 53 is disposed between the second friction member 52 and the engagement portions 51b and 51c of the first friction member 51 to urge both members in the axial direction, thereby making the structure simple.

The washer 54 is seated on the tips of the engagement portions 51b and 51c of the first friction member 51 to serve as a receiving member that receives the urging force from the cone spring 53. As a result, the axial load applied to the frictional sliding face becomes stable so that the frictional resistance generated at the sliding face is stabilized.

The first friction generation mechanism 5 is disposed radially inward of the clutch friction face 3a of the second flywheel 3, that is, apart from the clutch friction face 3a radially inward. As a result, the first friction generation mechanism 5 is unlikely to be affected by the heat from the clutch friction face 3a, thereby stabilizing the frictional resistance.

The first friction generation mechanism 5 is disposed radially inward of the radially middle portion of the first and second coil springs 34 and 35 of the damper mechanism 4 and radially outward of the radially outermost peripheries of the bolts 22. As a result, a space-saving structure is realized.

3-2) Effects of the Second Friction Generation Mechanism 6

Since the second friction generation mechanism 6 is supported by the first flywheel 2 (more specifically, the flexible plate 11), the second friction generation mechanism 6 is unlikely to be affected by the heat from the clutch friction face 3a of the second flywheel 3. As a result, the performance of the second friction generation mechanism 6 is stable. Especially, the first flywheel 2 is not connected to the second flywheel 3 via the coil springs 34 to 36, the heat is unlikely to be transmitted to the first flywheel 2 from the second flywheel 3.

The second friction generation mechanism 6 makes use of the annular portion 11a at the radially outer portion of the flexible plate 11 as a frictional face. Since the flexible plate 11 is utilized, the second friction generation mechanism 6 has fewer components in number, thereby simplifying the structure.

Since the second friction generation mechanism 6 is disposed radially outward of the clutch friction face 3a of the clutch and is apart from the clutch friction face 3a in the radial direction, the second friction generation mechanism 6 is unlikely to be affected by the heat from the clutch friction face 3a.

3-3) Effects of the Flexible Flywheel (the First Flywheel 2 and the Damper Mechanism 4)

The first flywheel 2 is a member having the inertia member 13 and the flexible plate 11 for connecting the inertia member 13 with the crankshaft 91. The flexible plate 11 is flexible in the bending and axial directions. The damper mechanism 4 includes the input-side disc-like plate 20 to which the torque is input from the crankshaft 91, the output-side disc-like plates 32 and 33 disposed rotatably relative to the input-side disc-like plate 20, and the coil springs 34, 35, and 36 to be compressed in the rotational direction when the plates are rotated relative each other. The damper mechanism 4 is directly connected to the crankshaft 91, that is, not via the first flywheel 2. The first flywheel 2 can move relative to the damper mechanism 4 in the bending direction within the predetermined range. A combination of the first flywheel 2 and the damper mechanism 4 described above is referred to as a flexible flywheel 66.

When the bending vibration is generated in the first flywheel 2, the flexible plate 11 is bent in the bending direction. As a result, the bending vibration from the engine is dampened. In the flexible flywheel, since the first flywheel 2 can move relative to the damper mechanism 4 in the bending direction within the predetermined range, the dampening effect of the flexible plate 11 on the bending vibration is sufficiently high.

The flexible flywheel 66 further includes the second friction generation mechanism 6, which is disposed between the first flywheel 2 and the output-side disc-like plate 32 of the damper mechanism 4 to operate in parallel with the coil springs 34, 35, and 36 in the rotational direction. The second friction generation mechanism 6 has the friction washers 57 and the frictional engagement members 60, which are engaged with each other to transmit the torque therebetween but are movable relative to each other in the bending direction. Since two members in the second friction generation mechanism 6 of the flexible flywheel 66 are engaged so as to be movable relative to each other in the bending direction, the first flywheel 2 can move within the predetermined range in the bending direction, although the first flywheel 2 is engaged with the damper mechanism 4 via the second friction generation mechanism 6. As a result, the dampening effect of the flexible plate 11 on the bending vibration is sufficiently high.

The friction washer 57 and the frictional engagement member 60 are engaged with each other with a clearance therebetween in the rotational direction. In other words, since both members are not in direct contact with each other in the rotational direction, relative movement in the bending direction does not generate large resistance.

The frictional engagement members 60 are engaged with the first plate 32 of the output-side disc-like plates 32 and 33 so as to move in the axial direction. As a result, when the friction washers 57 move with the first flywheel 2 in the axial direction, axial resistance is unlikely to be generated between the frictional engagement members 60 and the output-side disc-like plates 32 and 33.

3-4) Effects of the Third Coil Springs 36

The third coil spring 36 is a member for providing a sufficient stopper torque to the damper mechanism 4 by starting the operation in the torsion characteristics at an area in which the torsional angle becomes the largest. The third coil springs 36 are functionally disposed to operate in parallel with the first and second coil springs 34 and 35 in the rotational direction.

The third coil spring 36 has a wire diameter and a coil diameter smaller than those of the first and second coil springs 34 and 35 to a large extent (about a half) so that the third coil springs 36 occupy an less axial space less than the coil springs 34 and 35. As shown in FIG. 1, the third coil springs 36 are disposed radially outward of the first and second coil springs 34 and 35 and at a position corresponding to the clutch friction face 3a of the second flywheel 3. In other words, the radial positions of the third coil springs 36 are within an annular area between the inner diameter and the outer diameter of the clutch friction face 3a.

In this embodiment, presence of the third coil springs 36 heightens the stopper torque sufficiently to improve the performance, and devising sizes and positions of the third coil springs 36 realizes a space-saving structure. Especially, although the third coil spring 36 is located at a position in the second flywheel 3 corresponding to the clutch friction face 3a, where an axial thickness is large, an axial size of the portion is sufficiently small and is smaller than the axial size of a portion where the first and second coil springs 34 and 35 are disposed.

Furthermore, the third coil springs 36 are positioned at almost the same radial position of the stopper constituted by the projections 20c of the input-side disc-like plate 20 and the cut-and-bent abutting portions 43 and 44 of the output-side disc-like plates 32 and 33. As a result, the diameter of the whole structure becomes smaller compared to a structure in which the components are located at different radial positions.

### 2. Second Embodiment

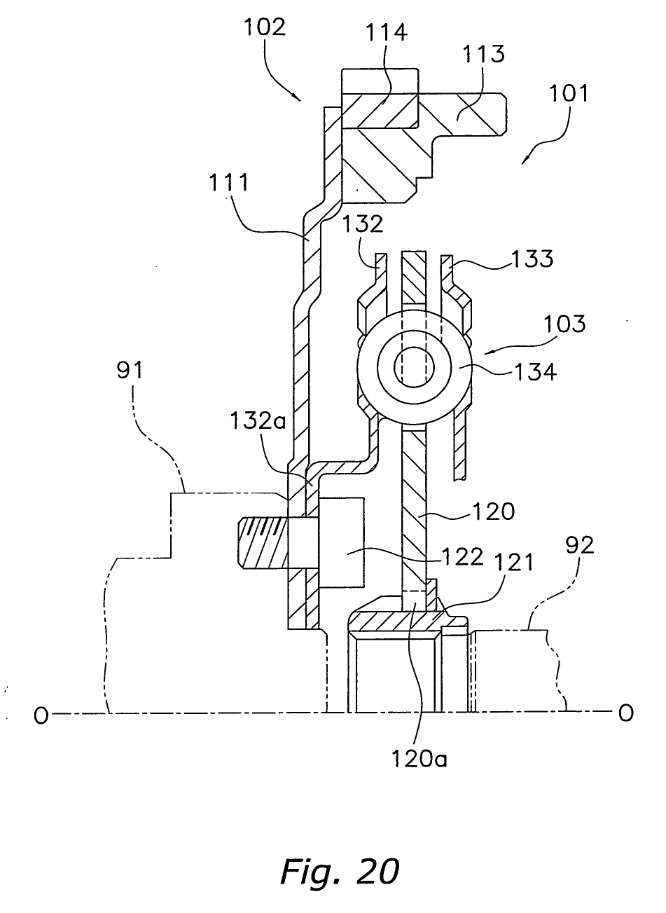

FIG. 20 shows a flexible flywheel 101 as a second embodiment according to the present invention. The flexible flywheel 101 is a device for transmitting torque from a crankshaft 91 of the engine to an input shaft 92 of the transmission. The flexible flywheel 101 is composed of a first flywheel 102 and a damper mechanism 103. The damper mechanism 103 is directly fixed to the crankshaft 91, and torque is not input to the damper mechanism 103 from the flywheel 102.

The first flywheel 102 includes an inertia member 113, and a flexible plate 111 for connecting the inertia member 113 with the crankshaft 91. The flexible plate 111 is flexibly deformable in the bending direction.

The damper mechanism 103 includes input-side disc-like plates 132 and 133 to which torque is input from the crankshaft 91, an output-side disc-like plate 120 rotatably located relative to the plates 132 and 133, and coil springs 134 to be compressed in the rotational direction when both the plates rotate relative to each other. The plates 132 and 133 are fixed to each other. The plate 132 has a radially inner portion 132a extending radially inward beyond a radially inner portion of the plate 133 and fixed to the crankshaft 91 by crankbolts 122 with a radially inner portion of the flexible plate 111. The output-side disc-like plate 120 has a radially inner portion 120a extending toward an outer circumferential surface of a hub 121 for engagement with each other so as not to rotate relative to each other. The plate 120 and the hub 121 cannot move relative to each other in the axial direction by a structure such as axially abutting surfaces and a snap ring.

Accordingly, unlike the first embodiment, the flexible flywheel 101 directly outputs torque to the input shaft 92 of the transmission, not via the second flywheel and the clutch, but via the hub 121.

As clear from FIG. 20, the first flywheel 102 has portions other than the radially inner portion apart from the damper mechanism 103 so that the first flywheel 102 can move relative to the damper mechanism 103 in the bending direction within a limited range.

When the bending vibrations are generated in the first flywheel 102, the flexible plate 111 flexes in the bending direction. Accordingly, the bending vibrations from the engine are attenuated. In this flexible flywheel 101, since the first flywheel 102 can move relative to the damper mechanism 103 in the bending direction within a limited range, the bending vibration suppressive effects by the flexible plate 111 is sufficiently high.

### 3. Third Embodiment

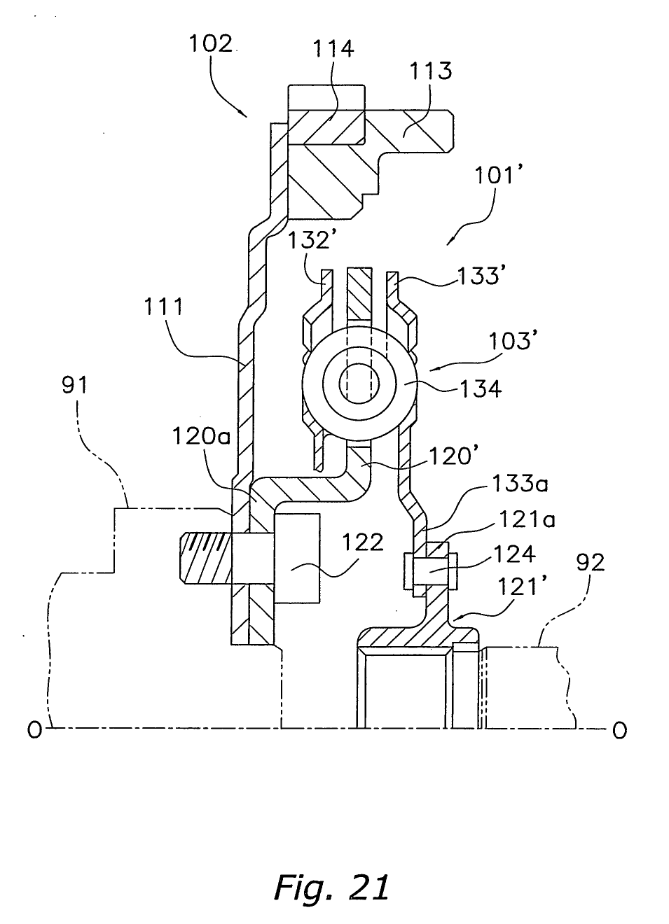

FIG. 21 shows a flexible flywheel 101′ as a third embodiment according to the present invention. Only different points will be described because the basic structures are the same as those of the second embodiment.

The damper mechanism 103′ includes an input-side disc-like plate 120′ to which torque is input from the crankshaft 91, output-side disc-like plates 132′ and 133′ rotatably located relative to the plate 120′, and coil springs 134 to be compressed in the rotational direction when the both plates rotate relative to each other. The plates 132′ and 133′ are fixed to each other. The plate 133 has a radially inner portion 133a extending radially inward beyond a radially inner portion of the plate 132 and fixed to a flange 121a of the hub 121′ by a plurality of rivets 124. The plate 120′ has a radially inner portion 120a fixed to the crankshaft 91 by crankbolts 122 with a radially inner portion of the flexible plate 111.

Accordingly, unlike the second embodiment, the plates 132′ and 133′ function as an output member, and the plate 120′ functions as an input member.

As it is clear from FIG. 21, the first flywheel 102 has portions other than the radially inner portion apart from the damper mechanism 103′ so that the first flywheel 102 can move relative to the damper mechanism 103′ in the bending direction within a limited range.

When the bending vibrations are generated in the first flywheel 102, the flexible plate 111 flexes in the bending direction. Accordingly, the bending vibrations from the engine are attenuated. In this flexible flywheel 101′, since the first flywheel 102 can move relative to the damper mechanism 103′ in the bending direction within a limited range, the bending vibration suppressive effects by the flexible plate 111 is sufficiently high.

### 4. Other Embodiment

Embodiments of the clutch mechanism in accordance with the present invention were described above, but the present invention is not limited to these embodiments and other variations or modifications that do not depart from the scope of the present invention are possible. More particularly, the present invention is not limited by the specific numerical values of angles and the like described above.

In the above-described embodiment, two size types of the rotational direction gap of the engagement portion were used, but it is also possible to use three or more size types. In the case of three size types, the magnitude of the intermediate frictional resistance will have two stages.

The coefficients of friction of the first friction member and the second friction member are the same as in the above-described embodiment, but these may also be varied. Thus, the ratio of the intermediate frictional resistance and large frictional resistance can be arbitrarily set by adjusting the frictional resistance generated by the first friction member and the second friction member.

In the above-described embodiment, intermediate frictional resistance is generated by providing convexities with an equal size and concavities with different sizes, but the concavities may be set to an equal size and the size of the convexities may be different. Furthermore, combinations of convexities and concavities with different sizes may also be used.

In the above-described embodiment, the concavity of the friction washer faces the internal side in the radial direction, but it may also face the external side in the radial direction.

In addition, the friction washer in the above-described embodiment has concavities, but the friction washer may also have convexities. In this case, the input-side disk-like plate has concavities, for example.

Furthermore, the friction washer in the above-described embodiment has a friction surface that is frictionally engaged with an input side member, but it may also have a friction surface that is frictionally engaged with an output member. In this case, an engagement portion having a rotational direction gap is formed between the friction washer and the input side member.

1. A flexible flywheel to which torque is input from a crankshaft of an engine, comprising:
a first flywheel having an inertia member and a flexible plate being configured to connect the inertia member with the crankshaft, the flexible plate being flexibly deformable in the bending direction and the axial direction; and
a damper mechanism including an input member to which torque is input from the crankshaft, an output member being located rotatable relative to the input member, and an elastic member being configured to be compressed in the a rotational direction when the input member and the output member rotate relative to each other;
the first flywheel being movable relative to the damper mechanism in the bending direction within a limited range.

2. A flexible flywheel according to claim 1, further comprising a friction generation mechanism located between the first flywheel and the output member of the damper mechanism to operate in parallel with the elastic member in the rotational direction, and
the friction generation mechanism includes two members which are engaged with to each other such that the two members can transmit torque therebetween but can move relative each other in the bending direction.

3. A flexible flywheel according to claim 2, wherein the two members are a friction member and an engagement member engaged with the friction member.

4. A flexible flywheel according to claim 3, wherein the friction member and the engagement member are engaged with each other to maintain a gap therebetween in the rotational direction.

5. A flexible flywheel according to claim 4, wherein the engagement member is further engaged with another member to be movable in the axial direction.

6. A flexible flywheel according to claim 5, further comprising a second flywheel fixed to
the output member of the damper mechanism.

7. A flexible flywheel according to claim 6, wherein the second flywheel has a frictional face with which a clutch is frictionally is engaged.

8. A flexible flywheel according to claim 4, wherein the friction member is configured to slide against the first flywheel in the rotational direction, and
the engagement member is configured to rotate integrally with the output member of the damper mechanism.

9. A flexible flywheel according to claim 8, wherein the engagement member is engaged with the output member of the damper mechanism to be movable relative to each other in the axial direction.

10. A flexible flywheel according to claim 9, further comprising a second flywheel fixed to the output member of the damper mechanism.

11. A flexible flywheel according to claim 10, wherein the second flywheel has a frictional face with which a clutch is frictionally engaged.

12. A flexible flywheel according to claim 3, wherein the engagement member is further engaged with another member to be movable in the axial direction.

13. A flexible flywheel according to claim 12, further comprising a second flywheel fixed to the output member of the damper mechanism.

14. A flexible flywheel according to claim 13, wherein the second flywheel has a frictional face with which a clutch is frictionally engaged.

15. A flexible flywheel according to claim 3, wherein the friction member is configured to slide against the first flywheel in the rotational direction, and
the engagement member is configured to rotate integrally with the output member of the damper mechanism.

16. A flexible flywheel according to claim 15, wherein the engagement member is engaged with the output member of the damper mechanism to be movable relative to each other in the axial direction.

17. A flexible flywheel according to claim 16, further comprising a second flywheel fixed to the output member of the damper mechanism.

18. A flexible flywheel according to claim 2, further comprising a second flywheel fixed to the output member of the damper mechanism.

19. A flexible flywheel according to claim 1, further comprising a second flywheel fixed to the output member of the damper mechanism.

20. A flexible flywheel according to claim 19, wherein the second flywheel has a frictional face with which a clutch is frictionally engaged.
